(19) United States
(12) Patent Application Publication
(10) Pub. No.: US 2021/0256367 A1
(43) Pub. Date: Aug. 19, 2021

(54) SCORING FOR SEARCH RETRIEVAL AND RANKING ALIGNMENT

(71) Applicant: Microsoft Technology Licensing, LLC, Redmond, WA (US)

(72) Inventors: Arashpreet Singh Mor, Milpitas, CA (US); Daniel Sairom Krishnan Hewlett, Sunnyvale, CA (US); Tanvi Sudarshan Motwani, Santa Clara, CA (US); Erik Buchanan, Sunnyvale, CA (US); Xiaoxia Feng, Santa Clara, CA (US); Ketan Thakkar, Sunnyvale, CA (US); James P. Luck, Philadelphia, PA (US)

(73) Assignee: Microsoft Technology Licensing, LLC, Redmond, WA (US)

(21) Appl. No.: 16/792,006

(22) Filed: Feb. 14, 2020

(51) Int. Cl. G06N 3/08; G06N 3/04; G06F 16/9535; G06F 16/951

(52) U.S. Cl. CPC G06N 3/08; G06F 16/951; G06F 16/9535; G06N 3/04

(57) ABSTRACT

The disclosed embodiments provide a system for processing searches. During operation, the system determines features related to attributes of candidates and interactions of the candidates with an online system. Next, the system applies a static ranking machine learning model to the features to produce scores representing likelihoods of outcomes related to the candidates and stores rankings of the candidates by descending values of the scores in entries of an inverted index. During processing of a search of the candidates in the online system, the system retrieves a subset of the candidates with the values of the scores that exceed a threshold from a subset of the entries in the inverted index that match parameters of the search. Finally, the system aggregates the retrieved subset of candidates for use in subsequent ordering of the subset of candidates by one or more dynamic ranking models.

### BACKGROUND

### Related Applications

The subject matter of this application is related to the subject matter in a co-pending non-provisional application entitled “Embedding Layer in Neural Network for Ranking Candidates,” having Ser. No. 16/449,110, and filing date 21 Jun. 2019 (Attorney Docket No. 902512-US-NP).

The subject matter of this application is also related to the subject matter in a co-pending non-provisional application entitled “Rescaling Layer in Neural Network for Ranking Candidates,” having Ser. No. 16/449,122, and filing date 21 Jun. 2019 (Attorney Docket No. 902513-US-NP).

### Field

The disclosed embodiments relate to processing searches. More specifically, the disclosed embodiments relate to techniques for generating machine learning scores for search retrieval and ranking alignment.

### RELATED ART

Online networks commonly include nodes representing individuals and/or organizations, along with links between pairs of nodes that represent different types and/or levels of social familiarity between the entities represented by the nodes. For example, two nodes in an online network are connected as friends, acquaintances, family members, classmates, and/or professional contacts. Online networks may further be implemented and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing searches in accordance with the disclosed embodiments.

FIG. 3 shows an example static ranking machine learning model in accordance with the disclosed embodiments.

FIG. 4 shows a flowchart illustrating the processing of a search in accordance with the disclosed embodiments.

FIG. 5 shows a flowchart illustrating a process of training a machine learning model to generate static ranking scores in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

Overview

The disclosed embodiments provide a method, apparatus, and system for processing searches in a manner that improves the relevance of search results and consumption of resources. In some embodiments, the searches include parameters that are matched to attributes of candidates. For example, the searches include parameters related to desired and/or required titles, skills, industries, years of experience, seniorities, education, and/or other professional attributes of candidates for jobs or other opportunities. The searches also, or instead, include parameters related to desired or required attributes of connections, follows, mentorships, referrals, online dating matches, and/or other types of relationships or interactions involving users of an online system.

During processing of a search, parameters (e.g., keywords, phrases, regular expressions, conditions, etc.) in the search are matched to entries of an inverted index that map the parameters to candidates with profile data or attributes that contain or are representative of the parameters. To expedite retrieval of the candidates from a number of search nodes, each search node returns a limited number of candidates that match a particular portion of the search instead of all candidates in the entry corresponding to the portion. Candidates returned by the search nodes are then ranked by descending score from one or more machine learning models, and some or all of the ranked candidates are returned as search results of the search. As a result, candidates at or near the top of a ranking may be deemed to be better qualified for the corresponding opportunity and/or relevant to the search parameters than candidates that are lower in the ranking.

More specifically, the disclosed embodiments provide a method, apparatus, and system for generating “static rank” scores for candidates mapped to a particular keyword or parameter in the inverted index. The static rank scores represent measures of importance of the candidates that are independent of the searches. For example, the static rank scores represent predicted likelihoods of engagement, popularity, and/or positive outcomes between the candidates and opportunities, independent of the relevance of the opportunities to the candidates and/or similarity or overlap between attributes of the candidates and corresponding attributes of the opportunities. The candidates are then ordered by descending static rank score in entries of the inverted index, which allows candidates with higher or better static rank scores to be returned in response to searches that contain the keyword. In turn, search results that contain rankings of the candidates are more relevant and/or higher quality than search results that are generated from candidates that are not retrieved according to the static rank scores.

To further improve the quality and/or relevance of the search results, a static ranking machine learning model is used to generate static rank scores by which candidates are ordered in the inverted index. For example, the static ranking machine learning model includes a deep neural network (DNN) that produces the static rank scores from embeddings of categorical features and/or continuous values of numeric features for the candidates. The features include, but are not limited to, attributes of the candidates and/or measures or indicators of the candidates' interactions with the online system and/or other entities (e.g., users, recruiters, connections, companies, schools, jobs, messages, etc.) in the online system.

The static ranking machine learning model is additionally trained to output scores that are aligned with objectives of one or more dynamic ranking models that are used to produce dynamic rankings of the candidates in the search results. For example, the dynamic ranking models generate scores representing predicted likelihoods of the outcomes, given parameters of the searches and attributes of the candidates and/or users performing the searches. The dynamic ranking models include a first-level dynamic ranking model that performs a first round of scoring, ranking, and/or filtering of the candidates using a first set of criteria, as well as a second-level dynamic ranking model that performs a second round of scoring and ranking of a smaller number of candidates with the highest scores from the first-level dynamic ranking model using a second set of criteria. The static ranking machine learning model is trained using the same labels and objective function (e.g., a loss function used to update model parameters in a way that reduces the error of the corresponding model) as the dynamic ranking models. The labels represent outcomes between users performing the searches and candidates in the corresponding search results, such as the candidates accepting or rejecting messages from the users after the candidates are viewed by the users in the search results. As a result, the static ranking machine learning model generates scores that reflect outcomes and/or objectives to be optimized in the searches and/or that mimic or approximate scores produced by the dynamic ranking models.

Because the static ranking machine learning model generates static rank scores that reflect outcomes to be optimized in searches, retrieval of candidates by descending static rank score during processing of the searches increases the likelihood of the outcomes after the candidates are delivered in search results of the searches. Users performing the searches are also able to identify qualified or desirable candidates more quickly, which reduces the amount of searching, browsing, filtering, and/or viewing of candidates performed by the users. The reduction in processing involved in the users' search-related activity additionally improves the utilization of processor, memory, storage, input/output (I/O), and/or other resources by the online system and/or the performance of applications, services, tools, and/or computer systems used to implement the online system.

The improved accuracy of the static rank scores allows for additional reductions in resource consumption during processing of the searches. In particular, static rank scores that are aligned with objectives related to dynamically ranking candidates in search results allow for reductions in the number of candidates to be scored or rescored by the dynamic ranking models. More accurate static rank scores also, or instead, allow fewer candidates to be retrieved from the inverted index, since a smaller number of higher quality candidates can produce the same or better outcomes than a larger number of lower quality candidates. This reduction in the number of retrieved candidates further reduces subsequent processing or scoring related to the candidates.

In contrast, conventional techniques perform search-based retrieval of entities in a way that is not tied to specific outcomes or objectives in the corresponding search results. Instead, these techniques retrieve the entities according to rankings of scores generated based on rules and/or metrics. As a result, users perform larger numbers of searches to find relevant or desirable candidates, which increases resource consumption and overhead. Conventional techniques also, or instead, retrieve all entities that match parameters of a search and perform scoring and ranking of the entities to generate search results of the search. In turn, the dynamic ranking models are required to score the much larger set of entities, which also increases computational overhead and/or latency associated with processing the search. Consequently, the disclosed embodiments may improve computer systems, applications, user experiences, tools, and/or technologies related to processing searches, generating recommendations, employment, recruiting, and/or hiring.

Scoring for Search Retrieval and Ranking Alignment

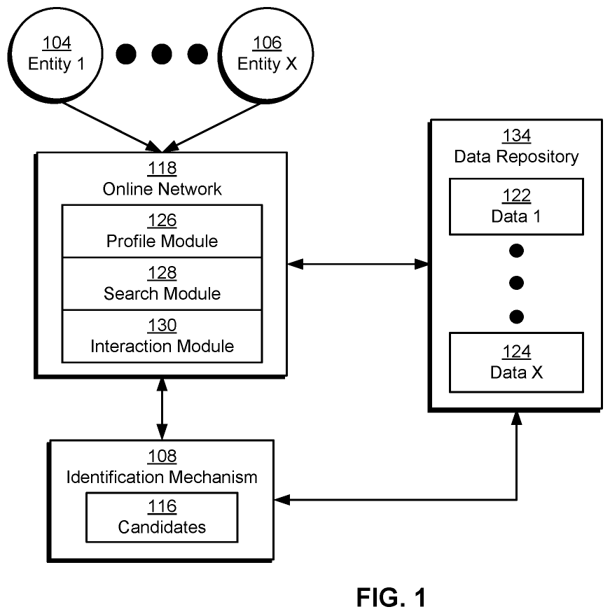

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations, search results, and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings of candidates associated with postings of jobs or opportunities within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 may be inputted into the machine learning model(s), along with features and/or characteristics of the corresponding opportunities (e.g., required or desired skills, education, experience, industry, title, etc.). In turn, the machine learning model(s) may output scores representing the strengths of candidates 116 with respect to the opportunities and/or qualifications related to the opportunities (e.g., skills, current position, previous positions, overall qualifications, etc.). For example, the machine learning model(s) generate scores based on similarities between the candidates' profile data with online network 118 and data in the posted opportunities. The model(s) optionally adjust the scores based on social and/or other validation of the candidates' profile data (e.g., endorsements of skills, recommendations, accomplishments, awards, patents, publications, reputation scores, etc.). The rankings are then generated by ordering candidates 116 by descending score.

In turn, rankings based on the scores improve the quality of candidates 116, recommendations of opportunities to candidates 116, and/or recommendations of candidates 116 for opportunities. Such rankings also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

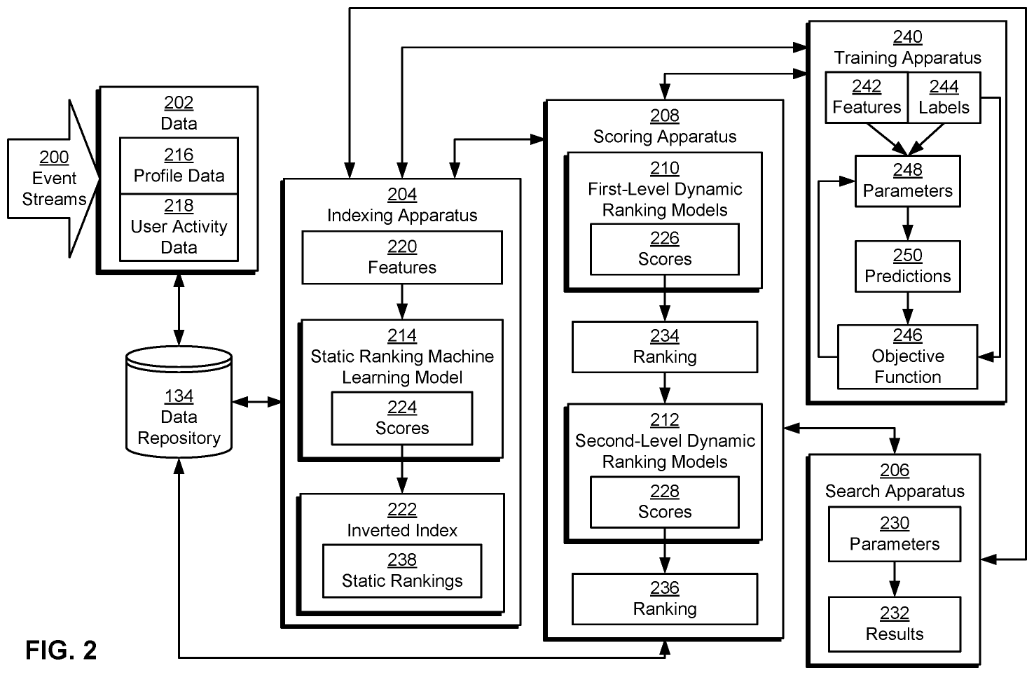

In one or more embodiments, online network 118 includes functionality to improve rankings of candidates 116 in search results by generating static ranking scores that prioritize the retrieval of certain types of candidates 116 during processing of the corresponding searches. As show in FIG. 2, data 202 from data repository 134 is used to generate rankings 234-236 of candidates in response to parameters 230 of searches by moderators of opportunities and/or other users. Data 202 includes profile data 216 for members of an online system (e.g., online network 118 of FIG. 1), as well as user activity data 218 that tracks the members' and/or candidates' activity within and/or outside the online system.

Profile data 216 includes data associated with member profiles in the online system. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, awards or honors earned by the user, licenses or certifications attained by the user, patents or publications associated with the user, and/or other data related to the user's interaction with the online system.

Attributes in profile data 216 for the members are optionally matched to a number of member segments, with each member segment containing a group of members that share one or more common attributes. For example, member segments in the online system may be defined to include members with the same industry, title, location, and/or language.

Connection information in profile data 216 is optionally combined into a graph, with nodes in the graph representing entities (e.g., users, schools, companies, locations, etc.) in the online system. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

User activity data 218 includes records of user interactions with one another and/or content associated with the online system. For example, user activity data 218 tracks impressions, clicks, likes, dislikes, shares, hides, comments, posts, updates, conversions, and/or other user interaction with content in the online system. User activity data 218 also, or instead, tracks other types of activity, including connections, messages, job applications, job searches, recruiter searches for candidates, interaction between candidates 116 and recruiters, and/or interaction with groups or events. In some embodiments, user activity data 218 further includes social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 additionally includes schedules, calendars, and/or upcoming availabilities of the users, which may be used to schedule meetings, interviews, and/or events for the users. Like profile data 216, user activity data 218 is optionally used to create a graph, with nodes in the graph representing members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

In one or more embodiments, profile data 216, user activity data 218, and/or other data 202 in data repository 134 is standardized before the data is used by components of the system. For example, skills in profile data 216 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, user activity data 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform. One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the platform is generated in response to the activity. The record is then propagated to components subscribing to event streams 200 on a nearline basis.

A search apparatus 206 uses data 202 in data repository 134 to identify candidates (e.g., candidates 116 of FIG. 1) that match parameters 230 of a search. For example, search apparatus 206 is provided by a recruiting module or search tool that is associated with and/or provided by the online system. Search apparatus 206 includes checkboxes, radio buttons, drop-down menus, text boxes, and/or other user-interface elements that allow a recruiter and/or another moderator involved in hiring for or placing jobs or opportunities to specify parameters 230 related to candidates for an opportunity and/or a number of related opportunities.

Parameters 230 include attributes that are desired or required by the position(s). For example, parameters 230 include thresholds, values, and/or ranges of values for an industry, location, education, skills, past positions, current positions, seniority, overall qualifications, title, seniority, keywords, awards, publications, patents, licenses and certifications, and/or other attributes or fields associated with profile data 216 for the candidates.

In some embodiments, search apparatus 206 matches or converts some or all parameters 230 to standardized attributes in data repository 202. For example, search apparatus 206 converts a misspelled, abbreviated, and/or non-standardized company name, title, location, skill, seniority, and/or other word or phrase in parameters 230 into a standardized identifier or value for a corresponding attribute. Search apparatus 206 also, or instead, adds standardized titles, skills, companies, and/or other attributes that are similar to those specified in parameters 230 to an updated set of parameters 230.

Search apparatus 206 and/or another component then query an indexing apparatus 204 for profile data 216 and/or other attributes of candidates that match parameters 230. In response to the query, indexing apparatus 204 matches parameters 230 to one or more entries in an inverted index 222 and retrieves candidates in postings lists stored in the entries from inverted index 222. For example, indexing apparatus 204 performs a lookup of each parameter (e.g., keyword, phrase, regular expression, etc.) in inverted index 222 to retrieve an index entry containing a mapping of the parameter to a set of candidates with profile data 216 and/or other data in which the parameter can be found.

In one or more embodiments, indexing apparatus 204 is executed using a number of search nodes distributed across one or more clusters, data centers, and/or other collections of resources. Each search node stores a subset of data in inverted index 222, such as a subset of identifiers for candidates and/or other entities to which parameters 230 are mapped in inverted index 222. To expedite processing of queries containing parameters 230, each search node returns a subset of candidates that match one or more parameters 230 instead of all candidates to which the parameter(s) are mapped in inverted index 222. For example, each of 32 search nodes returns 200 candidates that match parameters 230 of a query from search apparatus 206, resulting in the retrieval of 6400 total candidates in response to the query.

To improve the quality and/or relevance of search results 232 containing the retrieved candidates, the candidates are ordered in search results 232 based on features associated with the candidates, parameters 230, and/or the user performing the search. For example, the features include measurements or indicators of each candidate's degree of similarity or overlap with parameters 230; the candidate's level of interest in job-seeking, amount of job-related activity in the online system, and/or willingness to interact with recruiters; representations of parameters 230 and/or a context of the corresponding search; and/or the searching user's activity, behavior, or preferences on the online system.

A scoring apparatus 208 inputs the features into a series of dynamic ranking models, which include one or more first-level dynamic ranking models 210 and one or more second-level dynamic ranking models 212, to generate one or more sets of scores 226-228 for the candidates. Each set of scores 226-228 is then used to produce a corresponding ranking (e.g., rankings 234-236) of the candidates, and one or more rankings are used to populate search results 232 that are returned in response to a set of search parameters 230. In other words, first-level dynamic ranking models 210 and second-level dynamic ranking models 212 include machine learning models that are executed in an online, real-time, and/or near-real-time basis to dynamically rank candidates in search results 232 in response to the corresponding search parameters 230.

In some embodiments, first-level dynamic ranking models 210 and second-level dynamic ranking models 212 include decision trees, random forests, gradient boosted trees, regression models, neural networks, deep learning models, ensemble models, and/or other types of models that generate multiple rounds of scores 226-228 and/or rankings 234-236 for the candidates according to different sets of criteria and/or thresholds. Features inputted into first-level dynamic ranking models 210 and/or second-level dynamic ranking models 212 include metrics that represent the extent to which profile data 216 for the candidates match parameters 230 of a given search. These metrics include, but are not limited to, the number of terms, fraction of terms, and/or occurrences of terms in various portions of profile data 216 (e.g., the candidate's title, function, profile summary, etc.) for each candidate that match parameters 230. The features also, or instead, include representations of parameters 230, such as embeddings of strings in parameters 230 and/or Boolean values indicating the presence or absence of various types of attributes (e.g., first name, last name, company, title, industry, etc.) in parameters 230.

The features also, or instead, characterize the job-seeking behavior, activity level, and/or preferences of each candidate. For example, these types of features may include a job-seeker score that classifies a candidate's job-seeking status as a job seeker or non-job-seeker and/or estimates the candidate's level of job-seeking interest; the amount of time since a candidate has expressed openness or availability for new opportunities (e.g., as a profile setting and/or job search setting) and/or the candidate's openness to the new opportunities; and/or views, searches, applications, and/or other activity of a candidate with job postings and/or views or searches of company-specific pages in the platform.

The features also, or instead, include measures of the candidate's popularity with recruiters (and/or other moderators of opportunities) and/or the candidate's willingness to interact with recruiters. For example, the features may include the number of messages sent to the candidate by recruiters, the number of recruiter messages accepted by the candidate (e.g., as indicated by the candidate responding to the messages and/or selecting a user-interface element indicating interest in the messages), a percentage of messages accepted by the candidate, message delivery settings of the candidate, and/or the number of times the candidate has been viewed in search results (e.g., results 232) by recruiters.

The features also, or instead, indicate the candidate's level of activity with the platform. For example, the features may include a categorical feature that represents the candidate's number of visits to the platform over a given period (e.g., at least four times a week over a four-week period, at least once a week over a four-week period, at least once over a four-week period, and/or zero times over the four-week period). In another example, candidate activity features 224 may include a Boolean feature that indicates the candidate's online status with the platform (i.e., whether or not the candidate is currently logged in to and/or using the platform).

The features also, or instead, describe interaction, similarity, and/or interest between a recruiter (or another moderator) and each candidate. For example, the features may include the number of times the recruiter has viewed a given candidate within the recruiting tool and/or in search results. In another example, the features may include an affinity score between the recruiter and the candidate, which is calculated using a matrix decomposition of messages sent and/or accepted between a set of recruiters and a set of candidates. In a third example, the features may include the number of connections shared by the recruiter and candidate, the network distance (e.g., degrees of separation) between the recruiter and candidate, and/or the number of groups shared by the recruiter and candidate. In a fourth example, the features may include Boolean values indicating whether or not the regions, countries, industries, and/or attributes of the recruiter and candidate match.

Each score generated by first-level dynamic ranking models 210 and second-level dynamic ranking models 212 represents the likelihood of a positive outcome between the candidate and recruiter (e.g., the candidate accepting a message from the recruiter, given an impression of the candidate by the recruiter in search results 232; the recruiter responding to the candidate's job application; placing or advancing the candidate in a hiring pipeline for the job; scheduling of an interview of the candidate for the job; hiring of the candidate for the job; etc.). Thus, an improvement in the performance and/or precision of each model results in a corresponding increase in the rate of positive outcomes after the candidates are viewed by recruiters in search results 232.

In one or more embodiments, scoring apparatus 208 uses one or more first-level dynamic ranking models 210 to generate a first set of scores 226 from features for all candidates that match parameters 230 (e.g., all candidates returned by data repository 134 in response to a query containing parameters 230). Scoring apparatus 208 also generates ranking 234 by ordering the candidates by descending score from the first set of scores 226.

Next, scoring apparatus 208 obtains a subset of candidates with the highest scores 226 from ranking 234 (e.g., the top 100 to 1,000 candidates in ranking 234) and inputs additional features for the subset of candidates into one or more second-level ranking models 212. Scoring apparatus 208 obtains a second set of scores 228 from second-level ranking models 212 and generates ranking 236 by ordering the subset of candidates by descending score from the second set of scores 228.

As a result, first-level dynamic ranking models 210 perform a first round of scoring and ranking 234 and/or filtering of the candidates using a first of criteria, and second-level dynamic ranking models 212 perform a second round of scoring and ranking 234 of a smaller number of candidates with the highest scores 226 from first-level ranking models 210 using a second set of criteria (e.g., additional features that compare the candidates with parameters 230 and/or the behavior or preferences of the user conducting the search). The number of candidates scored by second-level dynamic ranking models 212 may be selected to accommodate performance and/or scalability constraints associated with generating results 232 in response to searches received through search apparatus 206. In turn, scores 226-228 generated by first-level dynamic ranking models 210 and second-level dynamic ranking models 212 account for the relevance of the candidates' profiles and/or experience to the corresponding search parameters 230

Search apparatus 206 then uses scores 226-228 and/or rankings 234-236 from scoring apparatus 208 to generate search results 232 that are displayed and/or outputted in response to the corresponding search parameters 230. For example, search apparatus 206 may paginate some or all candidates in ranking 236 into subsets of search results 232 that are displayed as the recruiter scrolls through the search results 232 and/or navigates across screens or pages containing the search results 232.

Search apparatus 206 and/or another component additionally include functionality to output multiple sets of search results 232 based on different rankings 234-236 of candidates by scores 226-228. For example, search apparatus 206 may output, in response to parameters 230 of a search by a recruiter, a first set of search results 232 that includes a “default” ranking of candidates by scores 226 or 228. Search apparatus 206 may also provide one or more user-interface elements that allow the recruiter to filter candidates in the search results by years of work experience, seniority, location, title, function, industry, level of activity on the online system, and/or other criteria. As a result, the system of FIG. 2 may allow the recruiter to manipulate and/or reorder results 232, depending on the recruiter's preferences and/or objectives with respect to a given opportunity or set of opportunities.

In one or more embodiments, indexing apparatus 204 includes functionality to generate inverted index 222 based on static rankings 238 of scores 224 for the candidates from a static ranking machine learning model 214. More specifically, indexing apparatus 204 applies static ranking machine learning model 214 to features 220 related to the candidates to produce “static rank” scores 224 representing query-independent measures of importance of candidates in search results 232 and/or other contexts related to recruiting or hiring. For example, scores 224 reflect the candidates' number of connections, followers, engagement with the online system, popularity, and/or openness to new jobs or opportunities. After static rank scores 224 are generated, indexing apparatus 204 stores, in postings lists of inverted index 222, static rankings 238 of candidates that are ordered by descending static rank score from static ranking machine learning model 214. Indexing apparatus 204 additionally retrieves candidates that match parameters 230 from inverted index 222 according to static rankings 238, so that candidates with the highest static rank scores 224 are used to generate results 232 of the search.

In some embodiments, features 220 include standardized attributes of candidates in profile data 216. For example, features 220 include sparse and/or encoded representations of the candidates' titles, skills, companies, industries, functions, schools, seniorities, years of experience, and/or locations.

Features 220 additionally include measures or indicators of interaction of the candidates with the online system and/or other users of the online system. For example, features 220 include, but are not limited to, scores representing each candidate's openness to new opportunities, level of job-seeking interest, willingness to accept messages, popularity, and/or level of engagement with the online system. Features 220 also, or instead, include rates of action associated with each candidate (e.g., the number of clicks or other actions on the candidate in search results 232 divided by the number of impressions of the candidate in search results 232 over the same period), the number of messages received over a period by the candidate from recruiters (or other users performing searches involving the candidate), the number of messages from recruiters accepted by the candidate over the same period, and/or other statistics related to the candidates' level of interaction in the online system. Features 220 also, or instead, include the number of months at a candidate's current company, the number of days since the candidate has expressed openness to new opportunities, and/or other measures of recency of events affecting the candidate's interest in opportunities.

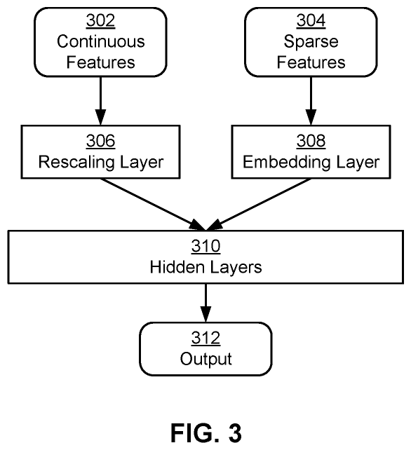

In one or more embodiments, static ranking machine learning model 214, first-level cynamic ranking models 210, and/or second-level dynamic ranking models 212 include one or more deep learning models. Each deep learning model uses multiple layers of a neural network to analyze features 220 and/or relationships among features 220 before producing scores 228 from features 220. As shown in FIG. 3, an example static ranking machine learning model (e.g., static ranking machine learning model 214 of FIG. 2) for generating output 312 that is used in a static ranking of candidates (or other entities) includes a rescaling layer 306, an embedding layer 308, and a number of hidden layers 310.

Input into rescaling layer 306 includes continuous features 302 of a candidate (or other type of entity). In some embodiments, continuous features 302 span one or more ranges of numeric values. For example, continuous features 302 include scores, metrics, periods of time, and/or other numeric values that characterize the candidate's level of engagement, popularity, willingness to interact with recruiters, openness to new opportunities, and/or interest in job-seeking. In turn, rescaling layer 306 normalizes or standardizes the range of values of each continuous feature to fall between 0 and 1, fall between −1 and 1, and/or have a mean of zero and/or a standard deviation of 1.

Input into embedding layer 308 includes sparse features 304 related to the candidate. For example, sparse features 304 include one-hot encodings of titles, skills, functions, industries, schools, locations, companies, and/or other standardized attributes of the candidate. Embedding layer 308 converts the one-hot encodings into embeddings that are vector representations of the corresponding attributes in a lower-dimensional space. Thus, a feature for skills with tens of thousands of possible values can be converted into an embedding with a dimensionality in the hundreds.

In another example, sparse features 304 includes a bag-of-words, sequential, and/or other representation of text in the candidate's profile data. The representation is inputted into embedding layer 308 and/or additional embedding layers of the deep learning model to produce one or more embeddings representing individual words, sequences of words, and/or other portions of the text.

Rescaled values outputted by rescaling layer 306 and embeddings outputted by embedding layer 308 are then inputted into a series of hidden layers 310 in the deep learning model to produce output 312. For example, each hidden layer includes a densely connected, tanh, softmax, and/or other layer that performs additional processing related to the output of rescaling layer 306, embedding layer 308, and/or preceding hidden layers in the deep learning model.

Output 312 produced by the final hidden layer is then used as a score that represents a prediction of a class, likelihood, preference, relationship, affinity, outcome, or other attribute related to the candidate. For example, output 312 includes a value between 0 and 1 representing the likelihood of a positive outcome involving the candidate. The outcome includes, but is not limited to, the candidate accepting or responding to a message from a recruiter, after the recruiter views the candidate in search results of the recruiter's search; interviewing of the candidate for an opportunity to be placed by the recruiter; the candidate receiving an offer for the opportunity; and/or the candidate accepting the offer.

In one or more embodiments, the static ranking machine learning model of FIG. 3 is trained to generate values of output 312 that reflects outcomes associated with pairs of members and jobs. For example, errors between likelihoods outputted by the static ranking machine learning model and positive or negative outcomes related to the candidates are backpropagated across layers and/or components of the machine learning model. As a result, parameters of rescaling layer 306, embedding layer 308, and/or hidden layers 310 are updated so that the static ranking machine learning model learns to predict the outcomes, given the corresponding continuous features 302 and sparse features 304. In turn, measures of “distance” between embeddings generated by embedding layer 308 can reflect outcomes related to the corresponding attributes or combinations of attributes in the candidates.

Those skilled in the art will appreciate that the model architecture of FIG. 3 may be used with other types of machine learning models. For example, rescaling layer 306, embedding layer 308, and hidden layers 310 may be used in one or more dynamic ranking models (e.g., first-level dynamic ranking models 210 and/or second-level dynamic ranking models 212 of FIG. 2) to produce scores representing likelihoods of positive outcomes between candidates and recruiters, given profile data 216 of the candidates, parameters 230 of the recruiters' searches, and/or other features. Embedding layers in deep learning models for ranking candidates are described in a co-pending non-provisional application entitled “Embedding Layer in Neural Network for Ranking Candidates,” having Ser. No. 16/449,110, and filing date 21 Jun. 2019, which is incorporated herein by reference. Rescaling layers in deep learning models for ranking candidates are described in a co-pending non-provisional application entitled “Rescaling Layer in Neural Network for Ranking Candidates,” having Ser. No. 16/449,122, and filing date 21 Jun. 2019, which is incorporated herein by reference.

Returning to the discussion of FIG. 2, a training apparatus 240 creates and/or updates static ranking machine learning model 214 based on training data that includes features 242 and labels 244 from data repository 134, indexing apparatus 204, and/or another data source. In some embodiments, features 242 include features 220 inputted into static ranking machine learning model 214, which can represent attributes of candidates and/or characterize the candidates' interaction with the online system or other users. Similarly, labels 244 represent outcomes related to the candidates. For example, a label of 1 indicates the occurrence of an outcome, and a label of 0 indicates the lack of occurrence of the outcome for a given sample in the training data.

In one or more embodiments, training apparatus 240 trains static ranking machine learning model 214 in a way that is aligned with the output and/or objectives of first-level dynamic ranking models 210 and/or second-level dynamic ranking models 212. For example, static ranking machine learning model 214 may be trained to generate scores that increase positive interactions and/or outcomes (e.g., correspondence between candidates and recruiters, interviewing of candidates, hiring of candidates) resulting from the searches and/or other goals related to searches of the candidates.

First, training apparatus 240 obtains training data for all static ranking machine learning model 214, first-level dynamic ranking models 210, and second-level dynamic ranking models 212 from the same set of candidates and/or data samples. For example, training data for static ranking machine learning model 214 includes features and labels 244 for the same searches (e.g., a set of searches spanning a given period) as training data for first-level dynamic ranking models 210 and second-level dynamic ranking models 212.

Second, the same labels 244 and objective function 246 are used for static ranking machine learning model 214, first-level dynamic ranking models 210, and second-level dynamic ranking models 212. For example, static ranking machine learning model 214, first-level dynamic ranking models 210, and second-level dynamic ranking models 212 are trained using the same labels 244, which represent the occurrence or lack of occurrence of positive outcomes related to the searches. In addition, labels 244 can be selected to optimize for different types of outcomes (e.g., acceptances of messages, responses to messages, advancement in hiring pipelines, offers, acceptances of offers, connection requests, conversions, etc.) related to users performing the searches and candidates (or other entities) in the corresponding search results. Similarly, static ranking machine learning model 214, first-level dynamic ranking models 210, and second-level dynamic ranking models 212 utilize the same objective function 246 (e.g., the same cross-entropy and/or mean squared error loss function that is used with stochastic gradient descent to minimize the error of each machine learning model), which can be selected based on the types of labels 244 to be learned, the types of machine learning models used, and/or other factors.

To train each machine learning model in static ranking machine learning model 214, first-level dynamic ranking models 210, and second-level dynamic ranking models 212, training apparatus 240 inputs features 242 in the training data into the machine learning model and obtains predictions 250 related to the features as output from the machine learning model. Training apparatus 240 calculates one or more values of objective function 246 based on differences between predictions 250 and the corresponding labels 244. Training apparatus 240 then uses an optimization technique (e.g., gradient descent and backpropagation) and/or one or more hyperparameters to update parameters 248 of the machine learning model in a way that optimizes objective function 246 (i.e., by reducing the error between predictions 250 and the corresponding labels 244).

In one or more embodiments, training apparatus 240 includes functionality to train static ranking machine learning model 214 to approximate the behavior of one or more dynamic ranking models (e.g., first-level dynamic ranking models 210, second-level dynamic ranking models 212) used to generate rankings 234-236 of candidates as search results 232. In these embodiments, some or all labels 244 used to update parameters 248 of static ranking machine learning model 214 include scores 226 or 228 outputted by the dynamic ranking model(s) to be approximated. As a result, static ranking machine learning model 214 learns to copy the output of the dynamic ranking model(s) instead of labels 244 used to train the dynamic ranking model(s). For example, static ranking model 214 learns to output a score of 0.7 produced by a given dynamic ranking model from a set of features instead of a label of 1 for the same set of features.

Those skilled in the art will appreciate that the behavioral approximation of the dynamic ranking model(s) by static ranking machine learning model 214 is performed in the absence of features related to parameters 230 or contexts of searches for which rankings scores 226-228 and rankings 234-236 are produced. To improve the ability of static ranking machine learning model 214 to mimic the dynamic ranking model(s) in the absence of query-specific features, some embodiments include selecting a larger set of features 242, a more complex architecture, and/or a larger number of parameters 248 for static ranking machine learning model 214 than the ranking machine learning model(s) to be approximated. As a result, static ranking machine learning model 214 can learn to make predictions 250 from patterns extracted from query-independent features 220 in a way that approximates scores generated by the dynamic ranking model(s) based on processing of query-specific features (e.g., parameters of a query, attributes of the user making the query, the context of the query, etc.). Such emulation of the dynamic ranking model(s) by static ranking machine learning model 214 further increases the alignment of scores 224 outputted by static ranking machine learning model 214 with the scores outputted by the ranking machine learning model(s). The trained static ranking machine learning model 214 can then be executed in an offline or batch-processing basis to produce scores 224 that are used to generated static rankings 238 of candidates in inverted index 222, while the smaller and/or less complex dynamic ranking model(s) can be deployed online to generate scores 226 or 228 that are used to rank candidates in search results 232 in an on-demand, real-time, or near-real-time basis.

After a given machine learning model (e.g., static ranking machine learning model 214, first-level dynamic ranking models 210, second-level dynamic ranking models 212) is trained and/or updated, training apparatus 240 stores parameters 248 of the machine learning model in a repository (not shown). For example, training apparatus 240 replaces old values of parameters 248 in the repository, or training apparatus 240 stores the updated parameters 240 separately from the old values (e.g., by storing each set of parameters with a different version number of the corresponding machine learning model). In turn, indexing apparatus 204, scoring apparatus 208, and/or other components of the system retrieve the latest versions of the machine learning model from training apparatus 240 and/or the repository and use the machine learning model to retrieve and rank candidates during processing of searches performed via search apparatus 206, as discussed above.

In one or more embodiments, indexing apparatus 204 and/or another component of the system include functionality to blend scores 224 from static ranking machine learning model 214 with older values of scores 224 used to generate older versions of static rankings 238 in inverted index 222. For example, the older values of scores 224 may be produced by an older version of static ranking machine learning model 214, a set of rules, an equation, and/or another technique. The older values additionally reflect an objective or outcome that is different from that of first-level dynamic ranking models 210 and/or second-level dynamic ranking models 212 used to rank the retrieved candidates in search results 232. As a result, search results 232 generated from static rankings 238 of the older score values can have lower relevance and/or performance than search results 232 generated from static rankings 238 of newer scores 224 by static ranking machine learning model 214. On the other hand, first-level dynamic ranking models 210 and second-level dynamic ranking models 212 may initially be trained on candidates retrieved according to static rankings 238 of the older score values, which can result in unexpected and/or undesirable effects when a sudden switch is made to retrieve candidates based on static rankings 238 of the newer scores 224 from static ranking machine learning model 214.

To mitigate potential adverse effects during the switch from older values of scores 224 to the newer values outputted by static ranking machine learning model 214, the component calculates a blended score as a normalized weighted average of each new score produced by static ranking machine learning model 214 with an older value of the same score and uses the combined score to generate static rankings 238. For example, the component selects a value λ that ranges between 0 and 1, scales the new score by λ, and scales the older value of the score by 1-λ. The component then sums the scaled values into a blended score and orders candidates in static rankings 238 by descending blended score.

The component additionally adjusts the calculation of the blended scores as first-level dynamic ranking models 210 and second-level dynamic ranking models 212 adapt to candidates retrieved based on scores 224 outputted by static ranking machine learning model 214. Continuing with the above example, the component calculates an initial set of blended scores using a low value for λ and generates a new inverted index 222 containing a set of static rankings 238 from the blended scores 244. The component also maintains an older version of inverted index 222 containing static rankings 238 of the older score values. Next, search apparatus 206 uses an A/B test to expose an “A” set of searches to search results 232 containing candidates retrieved from static rankings 238 in the old inverted index 222 and a “B” set of searches to search results 232 containing candidates retrieved from static rankings 238 in the new inverted index 222. The component collects outcomes related to search results 232 for both sets of searches and generates performance metrics (e.g., precision, normalized discounted cumulative gain, etc.) from the outcomes. Training apparatus 240 subsequently trains new versions of first-level dynamic ranking models 210 and second-level dynamic ranking models 212 using labels 244 representing outcomes collected from the “B” set, and scoring apparatus 208 uses the new versions of first-level dynamic ranking models 210 and second-level dynamic ranking models 212 to generate search results 232 for additional searches in the “B” set. At the same time, scoring apparatus 208 continues using older versions of first-level dynamic ranking models 210 and second-level dynamic ranking models 212 trained on candidates retrieved from static rankings 238 in the old inverted index 222 to generate search results 232 for searches in the “A” set.

Continuing with the above example, the process is repeated with new blended scores calculated from increasing values of λ. As λ and the proportion of the new scores 224 in the blended scores increase, the performance metrics are monitored to ensure that the performance of the “B” set is at least as good as that of the “A” set. Additional increases to λ are made until the new versions of first-level dynamic ranking models 210 and second-level dynamic ranking models 212 are trained to predict outcomes for search results 232 containing candidates from static rankings 238 of only the new scores 224 (i.e., when λ=1). Searches in the online system can then be gradually transitioned to retrieval of candidates from the new inverted index 222 by gradually ramping larger proportions of searches to the “B” set. During such ramping, the performance metrics are monitored to ensure that the “B” set does not adversely impact the outcomes of searches performed within the online system.

Because static ranking machine learning model 214 generates static rank scores 224 that reflect outcomes to be optimized in searches, retrieval of candidates by descending static rank score during processing of the searches increases the likelihood of the outcomes after the candidates are delivered in search results 232 of the searches. Users performing the searches are also able to identify qualified or desirable candidates more quickly, which reduces the amount of searching, browsing, filtering, and/or viewing of candidates performed by the users. The reduction in processing involved in the users' search-related activity additionally improves the utilization of processor, memory, storage, input/output (I/O), and/or other resources by the online system and/or the performance of applications, services, tools, and/or computer systems used to implement the online system.

The improved accuracy of the static rank scores 224 allows for additional reductions in resource consumption during processing of the searches. In particular, static rank scores 224 that are aligned with objectives (e.g., loss functions, labels in training data, scores outputted by dynamic ranking models, etc.) related to ranking candidates in search results 232 allow for reductions in the number of candidates to be scored or rescored by first-level dynamic ranking models 210 and/or second-level dynamic ranking models 212. More accurate static rank scores 224 also, or instead, allow fewer candidates to be retrieved from inverted index 222, since a smaller number of higher quality candidates can produce the same or better outcomes than a larger number of lower quality candidates. This reduction in the number of retrieved candidates further reduces subsequent processing or scoring related to the candidates.

In contrast, conventional techniques perform search-based retrieval of entities in a way that is not tied to specific outcomes or objectives in the corresponding search results. Instead, these techniques retrieve the entities according to rankings of scores generated based on rules, metrics, and/or other criteria. As a result, users perform larger numbers of searches to find relevant or desirable candidates, which increases resource consumption and overhead in systems processing the searches. Conventional techniques also, or instead, retrieve all entities that match parameters of a search and perform scoring and ranking of the entities to generate search results of the search. In turn, the dynamic ranking models are required to score the much larger set of entities, which also increases computational overhead and/or latency associated with processing the search. Consequently, the disclosed embodiments may improve computer systems, applications, user experiences, tools, and/or technologies related to processing searches, generating recommendations, employment, recruiting, and/or hiring.

Those skilled in the art will appreciate that the system of FIG. 2 may be implemented in a variety of ways. First, indexing apparatus 204, scoring apparatus 208, search apparatus 206, training apparatus 240, and/or data repository 134 may be provided by a single physical machine, multiple computer systems, one or more virtual machines, a grid, one or more databases, one or more filesystems, and/or a cloud computing system. Indexing apparatus 204, scoring apparatus 208, search apparatus 206, and/or training apparatus 240 may additionally be implemented together and/or separately by one or more hardware and/or software components and/or layers.

Second, a number of machine learning models and/or techniques may be used to generate scores 224-228 and/or rankings 234-238. For example, the functionality of each machine learning model may be provided by a regression model, artificial neural network, support vector machine, decision tree, random forest, gradient boosted tree, naïve Bayes classifier, Bayesian network, clustering technique, collaborative filtering technique, deep learning model, hierarchical model, and/or ensemble model. The retraining or execution of each machine learning model may also be performed on an offline, online, and/or on-demand basis to accommodate requirements or limitations associated with the processing, performance, or scalability of the system and/or the availability of features 242 and labels 244 used to train the machine learning model. Multiple versions of a machine learning model may further be adapted to different subsets of candidates, recruiters, and/or search parameters 230 (e.g., different member segments or types of searches), or the same machine learning model may be used to generate one or more sets of scores (e.g., scores 224-228) for all candidates and/or recruiters in the platform. Similarly, the functionality of first-level dynamic ranking models 210 and second-level dynamic ranking models 212 may be merged into a single machine learning model that performs a single round of scoring and ranking of the candidates. Conversely, static ranking machine learning model 214, first-level dynamic ranking models 210, and/or second-level dynamic ranking models 212 may be separated out into additional machine learning models that perform multiple rounds of scoring, filtering, and/or ranking of the candidates in support of various search-related functions.

Third, the system of FIG. 2 may be adapted to generate search results 232 or recommendations for various types of searches and/or entities. For example, the functionality of the system may be used to improve and/or personalize search results 232 or recommendations containing candidates for academic positions, artistic or musical roles, school admissions, fellowships, scholarships, competitions, club or group memberships, matchmaking, professional or personal connections, and/or other types of opportunities. In another example, the functionality of the system may be used to retrieve and rank search results 232 containing web pages, goods, services, businesses, homes, schools, files, applications, and/or other types of entities.

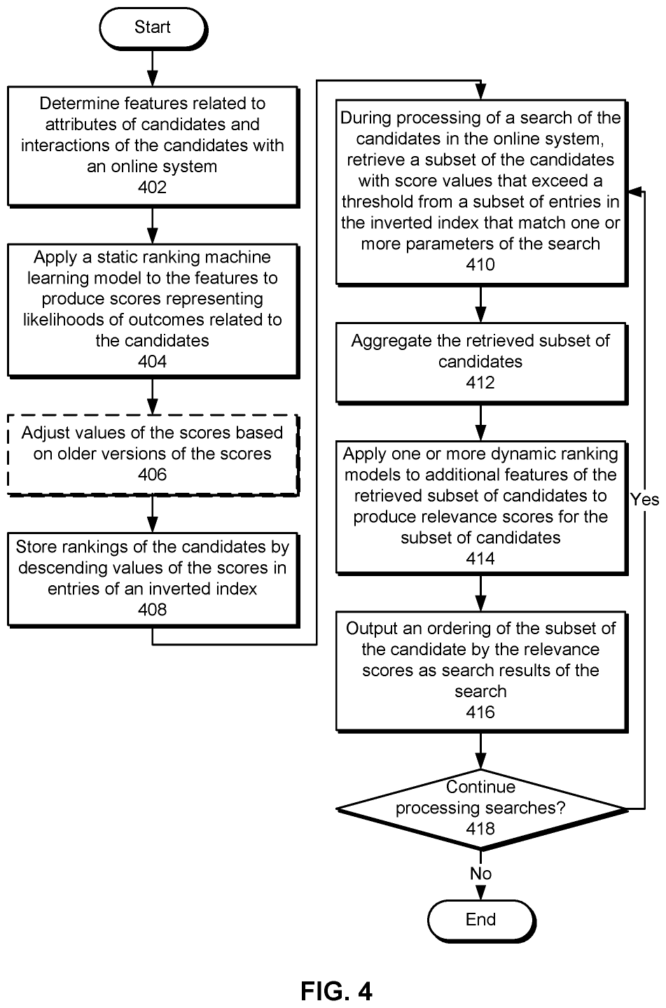

FIG. 4 shows a flowchart illustrating the processing of a search in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, features related to attributes of candidates and interactions of the candidates with an online system are determined (operation 402). For example, the features include sparse representations (e.g., one-hot encodings) of the attributes of the candidates and/or numeric features that characterize the candidates' interactions with the online system. The attributes include, but are not limited to, a title, skill, industry, school, and/or company of each candidate. Each numeric feature represents the popularity of a candidate, the candidate's interest in opportunities, a recency of an event affecting the candidate's interest in opportunities (e.g., how long the candidate has been at his/her current job, how long ago did the candidate indicate openness to new opportunities, etc.), a level of interaction between the candidate and other users of the online system, and/or an engagement of the candidate with the online system.

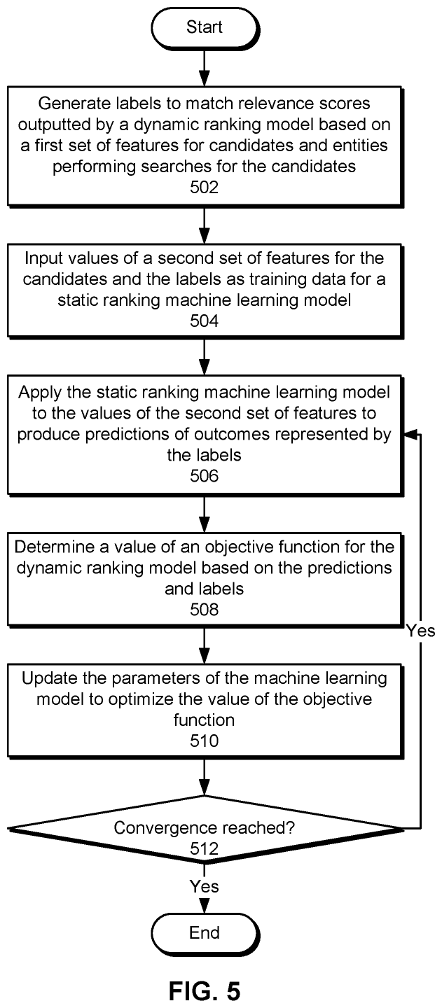

Next, a static ranking machine learning model is applied to the features to produce scores representing likelihoods of outcomes related to the candidates (operation 404). For example, the static ranking machine learning model includes a deep learning model with a number of layers. Sparse features representing the attributes of the candidates are inputted into one or more embedding layers of the static ranking machine learning model, and continuous features representing the interactions of the candidates with the online system are inputted into one or more rescaling layers of the static ranking machine learning model. One or more hidden layers in the static ranking machine learning model are then applied to the output of the embedding and rescaling layers to produce the scores. In addition, the static ranking machine learning model is trained to produce the scores based on additional scores representing predictions of the likelihoods by one or more dynamic ranking models that dynamically order the candidates in search results of searches in the online system, as described in further detail below with respect to FIG. 5.

Values of the scores are optionally adjusted based on older versions of the scores (operation 406). For example, each score outputted by the static ranking machine learning model is adjusted to be a normalized weighted average of the score and an older version of the score. Weights used to calculate the normalized weighted average are also selected and/or adjusted based on performance metrics associated with search results related to the candidates.

Rankings of the candidates are then stored by descending values of the scores in entries of an inverted index (operation 408). For example, the inverted index includes keywords and/or other parameters by which the candidates can be searched. Each parameter is mapped to a postings list of candidates that match the parameter. Within the postings list, the candidates are sorted by descending score from the static ranking machine learning model, so that candidates with higher likelihoods of outcomes predicted by the static ranking machine learning model (e.g., accepting or responding to messages from other users searching for the candidates) appear earlier in the postings list than candidates with lower predicted likelihoods of the outcomes.

During processing of a search of the candidates in the online system, a subset of the candidates with score values that exceed a threshold are retrieved from a subset of rankings in the inverted index that match one or more parameters of the search (operation 410). For example, the search is processed by a number of search nodes, each storing a shard or partition of the inverted index containing a subset of the candidates. Each search node matches the parameters(s) to one or more entries in the inverted index. For each of the entries matching the parameter(s) of the search, the search node retrieves a pre-specified number of candidates from the front of the postings list.

The retrieved subset of candidates is then aggregated (operation 412). Continuing with the above example, candidates retrieved by the search nodes are collected into a centralized location or repository for use in subsequent ordering of the subset of the candidates by one or more ranking machine learning models.

One or more dynamic ranking models are then applied to additional features of the retrieved subset of candidates to produce relevance scores for the subset of candidates (operation 414). For example, the dynamic ranking model(s) are applied to features representing the parameters, the compatibility of the candidates with the parameters, and/or the compatibility of the candidates with a user performing the search to produce relevance scores representing updated likelihoods of the outcomes in the context of that particular search.

Finally, an ordering of the subset of candidates by the relevance scores is outputted as search results of the search (operation 416). For example, the subset of candidates may be ordered by descending relevance score in the search results, and one or more pages of the search results are displayed, transmitted, and/or otherwise outputted to the user performing the search.

Operations 410-416 may be repeated to process additional searches (operation 418) of the candidates. As the searches are processed and outcomes related to the searches collected, operations 406-408 may be repeated to increase the contributions of the scores and decrease the contributions of the older versions of the scores to the static rankings in the inverted index, and the dynamic ranking model(s) may be retrained based on the outcomes. The process may be repeated until the older versions of the scores are “phased out” in processing searches of the candidates.

FIG. 5 shows a flowchart illustrating a process of training a machine learning model to generate static ranking scores in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, labels are generated to match relevance scores outputted by a dynamic ranking model based on a first set of features for candidates and entities performing searches for the candidates (operation 502). For example, the dynamic ranking model generates relevance scores that are used to rank the candidates in search results for the entities' searches. The labels are generated to match the relevance scores to approximate the behavior of the dynamic ranking model. Alternatively or additionally, the labels are generated to represent the actual outcomes between the candidates and entities.

Next, values of a second set of features for the candidates and the labels are inputted as training data for a static ranking machine learning model (operation 504), and parameters of the static ranking machine learning model are updated based on the training data and an objective function for the dynamic ranking model. In particular, the static ranking machine learning model is applied to the values of the second set of features to produce predictions of outcomes represented by the labels (operation 506). For example, the second set of features is processed by one or more layers of the machine learning model to produce scores between 0 and 1 that represent likelihoods of the outcomes.

A value of the objective function for the dynamic ranking model is then determined based on the predictions and labels (operation 508), and the parameters of the static ranking machine learning model are updated to optimize the value of the objective function (operation 510). For example, the objective function is used to calculate an error between the predictions and labels, and gradient descent and/or another optimization technique are used to adjust the parameters of the static ranking machine learning model in a way that reduces the error. Operations 506-510 may be repeated over a series of training iterations and/or epochs until convergence is reached (operation 512) in the objective function.

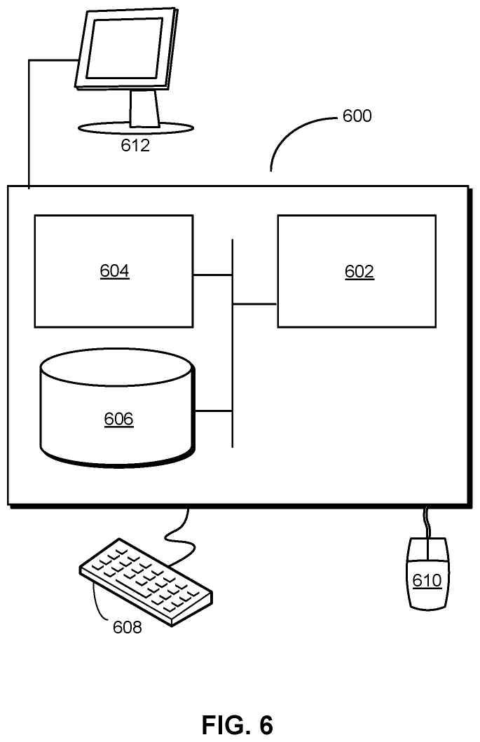

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing searches. The system includes an indexing apparatus, a training apparatus, a search apparatus, and a scoring apparatus, one or more of which may alternatively be termed or implemented as a module, mechanism, or other type of system component. The indexing apparatus determines, based on data retrieved from a data store, features related to attributes of candidates and interactions of the candidates with an online system. Next, the indexing apparatus performs one or more operations that apply a static ranking machine learning model to the features to produce scores representing likelihoods of outcomes related to the candidates. The indexing apparatus then stores rankings of the candidates by descending values of the scores in entries of an inverted index. During processing of a search of the candidates in the online system, the search apparatus retrieves a subset of the candidates with the values of the scores that exceed a threshold from a subset of the entries in the inverted index that match one or more parameters of the search. The search apparatus also aggregates the retrieved subset of the candidates for use in subsequent ordering of the subset of the candidates by the one or more dynamic ranking models.

The training apparatus inputs, for additional candidates, values of the features and labels representing the outcomes as training data for the static ranking machine learning model. The training apparatus then updates parameters of the static ranking machine learning model based on the training data and an objective function for a dynamic ranking model that generates relevance scores used to order the subset of the candidates in search results of the search.

The scoring apparatus applies the dynamic ranking model to additional features of the retrieved subset of candidates to produce relevance scores for the subset of candidates. The search apparatus then outputs an ordering of the subset of candidates by the relevance scores as search results of the search.

In addition, one or more components of computer system 600 may be remotely located and connected to the other components over a network. Portions of the present embodiments (e.g., indexing apparatus, training apparatus, search apparatus, scoring apparatus, data repository, online network, etc.) may also be located on different nodes of a distributed system that implements the embodiments. For example, the present embodiments may be implemented using a cloud computing system that generates static ranking scores, inverted indexes, and/or search results related to a set of remote candidates and/or entities.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with Lite members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining features related to attributes of candidates and interactions of the candidates with an online system;
applying a static ranking machine learning model to the features to produce scores representing likelihoods of outcomes related to the candidates, wherein the static ranking machine learning model is trained to produce the scores based on additional scores representing predictions of the likelihoods by one or more dynamic ranking models that order the candidates in search results of searches in the online system;
storing rankings of the candidates by descending values of the scores in entries of an inverted index;
during processing of a search of the candidates in the online system, retrieving a subset of the candidates with the values of the scores that exceed a threshold from a subset of the entries in the inverted index that match one or more parameters of the search; and
aggregating the retrieved subset of the candidates for use in subsequent ordering of the subset of the candidates by the one or more dynamic ranking machine learning models.

2. The method of claim 1, further comprising:
inputting, for additional candidates, values of the features and labels representing the outcomes as training data for the static ranking machine learning model; and
updating parameters of the static ranking machine learning model based on the training data and an objective function for the one or more dynamic ranking models.

3. The method of claim 2, further comprising:
generating the labels to match relevance scores outputted by the one or more dynamic ranking models, wherein the relevance scores are determined by the one or more dynamic ranking models based on additional features for the additional candidates and entities performing searches for the additional candidates.

4. The method of claim 2, wherein updating the parameters of the static ranking machine learning model comprises:
applying the static ranking machine learning model to the values of the features to produce predictions of the outcomes;
determining a value of the objective function based on the predictions and the labels; and
updating the parameters of the static ranking machine learning model to optimize the value of the objective function.

5. The method of claim 1, wherein performing the one or more operations that apply the machine learning model to the features to produce the scores comprises:
inputting a first subset of the features representing the attributes of the candidates into one or more embedding layers of the static ranking machine learning model;
inputting a second subset of the features representing the interactions of the candidates with the online system into one or more rescaling layers of the static ranking machine learning model; and
applying one or more hidden layers in the static ranking machine learning model to the output of the one or more embedding layers and the one or more rescaling layers to produce the scores.

6. The method of claim 5, wherein determining the features related to the attributes of the candidates comprises:
generating sparse representations of the attributes of the candidates, wherein the attributes comprise at least one of a title, a skill, an industry, a school, and a company.

7. The method of claim 5, wherein determining the features related to the interactions of the candidates with the online system comprises:
determining one or more features related to at least one of a popularity of a candidate, an interest of the candidate in opportunities, a recency of an event affecting the interest of the candidate in the opportunities, a level of interaction between the candidate and other users of the online system, and an engagement of the candidate with the online system.

8. The method of claim 1, further comprising:
prior to storing the rankings of the candidates by the descending values of the scores in the inverted index, adjusting the values of the scores from the static ranking machine learning model based on older versions of the scores.

9. The method of claim 8, wherein adjusting the values of the scores from the static ranking machine learning model based on the older versions of the scores comprises:
calculating a normalized weighted average of a score from the machine learning model and an older version of the score.

10. The method of claim 8, wherein adjusting the values of the scores from the static ranking machine learning model based on the older versions of the scores further comprises:
adjusting weights used to calculate the normalized weighted average based on performance metrics associated with search results of the search and additional searches.

11. The method of claim 1, further comprising:
applying the one or more dynamic ranking models to additional features of the retrieved subset of the candidates to produce relevance scores for the subset of the candidates; and
outputting an ordering of the subset of the candidates by the relevance scores as search results of the search.

12. The method of claim 1, wherein the outcomes comprise acceptances of messages from users searching for the candidates by the candidates.

13. A system, comprising:
one or more processors; and
memory storing instructions that, when executed by the one or more processors, cause the system to:
determine features related to attributes of candidates and interactions of the candidates with an online system;
apply a static ranking machine learning model to the features to produce scores representing likelihoods of outcomes related to the candidates, wherein the static ranking machine learning model is trained to produce the scores based on additional scores representing predictions of the likelihoods by one or more dynamic ranking models that order the candidates in search results of searches in the online system;
store rankings of the candidates by descending values of the scores in entries of an inverted index;
during processing of a search of the candidates in the online system, retrieve a subset of the candidates with the values of the scores that exceed a threshold from a subset of the entries in the inverted index that match one or more parameters of the search; and
aggregate the retrieved subset of the candidates for use in subsequent ordering of the subset of the candidates by the one or more ranking machine learning models.

14. The system of claim 13, wherein the memory further stores instructions that, when executed by the one or more processors, cause the system to:
input, for additional candidates, values of the features and labels representing the outcomes as training data for the static ranking machine learning model; and
update parameters of the static ranking machine learning model based on the training data and an objective function for the one or more dynamic ranking models.

15. The system of claim 14, wherein the memory further stores instructions that, when executed by the one or more processors, cause the system to:
generate the labels to match relevance scores outputted by the one or more dynamic ranking models, wherein the relevance scores are determined by the one or more dynamic ranking models based on additional features for the additional candidates and entities performing searches for the additional candidates.

16. The system of claim 13, wherein performing the one or more operations that apply the machine learning model to the features to produce the scores comprises:
inputting a first subset of the features representing the attributes of the candidates into one or more embedding layers of the static ranking machine learning model;
inputting a second subset of the features representing the interactions of the candidates with the online system into one or more rescaling layers of the static ranking machine learning model; and
applying one or more hidden layers in the static ranking machine learning model to the output of the one or more embedding layers and the one or more rescaling layers to produce the scores.

17. The system of claim 13, wherein determining the features comprises:
generating sparse representations of the attributes of the candidates, wherein the attributes comprise at least one of a title, a skill, an industry, a school, and a company; and
determining one or more features related to at least one of a popularity of a candidate, an interest of the candidate in opportunities, a recency of an event affecting the interest of the candidate in the opportunities, a level of interaction between the candidate and other users of the online system, and an engagement of the candidate with the online system.

18. The system of claim 13, wherein the memory further stores instructions that, when executed by the one or more processors, cause the system to:
prior to storing the rankings of the candidates by the descending values of the scores in the inverted index, adjust the values of the scores by calculating normalized weighted averages of the scores and older versions of the scores.

19. The system of claim 13, wherein the memory further stores instructions that, when executed by the one or more processors, cause the system to:
apply the one or more dynamic ranking models to additional features of the retrieved subset of the candidates to produce relevance scores for the subset of the candidates; and
output an ordering of the subset of the candidates by the relevance scores as search results of the search.

20. A non-transitory computer-readable storage medium storing instructions that when executed by a computer cause the computer to perform a method, the method comprising:
determining features related to attributes of candidates and interactions of the candidates with an online system;
apply a static ranking machine learning model to the features to produce scores representing likelihoods of outcomes related to the candidates, wherein the static ranking machine learning model is trained to produce the scores based on additional scores representing predictions of the likelihoods by one or more dynamic ranking models that order the candidates in search results of searches in the online system;
storing rankings of the candidates by descending values of the scores in entries of an inverted index;
during processing of a search of the candidates in the online system, retrieving a subset of the candidates with the values of the scores that exceed a threshold from a subset of the entries in the inverted index that match one or more parameters of the search; and
aggregating the retrieved subset of the candidates for use in subsequent ordering of the subset of the candidates by the one or more dynamic ranking models.
